(19) United States
(12) Patent Application Publication
(10) Pub. No.: US 2018/0173778 A1
(43) Pub. Date: Jun. 21, 2018

(54) DATABASE UNIQUENESS CONSTRAINTS

(71) Applicant: LinkedIn Corporation, Sunnyvale, CA (US)

(72) Inventors: Shangcheng Ying, Shanghai (CN); Jianhong Fang, Milpitas, CA (US); Bharat Patel, Fremont, CA (US); Sandip Davda, Fremont, CA (US); Yellamraju Venkata Srinivas, Cupertino, CA (US); Rongsheng Liang, Cupertino, CA (US)

(21) Appl. No.: 15/382,167

(22) Filed: Dec. 16, 2016

(51) Int. Cl. G06F 17/30

(52) U.S. Cl. CPC G06F 17/30575; G06F 17/30371; G06F 17/30377

(57) ABSTRACT

Systems and methods are disclosed for employing database uniqueness constraints. In one implementation, a first record can be received for insertion at a database at a first data center. The database can include record(s) that are replicated across the first data center and a second data center. The first record can be inserted into the database on the first data center and into a shadow table corresponding to field(s) of the database on the first data center that are associated with unique constraint(s). A second record can be received at the first data center. An attempt to insert the second record into the shadow table can be made. In response to a determination that the second record conflicts with the first record as stored in the shadow table with respect to the unique constraint(s), insertion of the second record into the database on the first data center can be prevented.

### TECHNICAL FIELD

Aspects and implementations of the present disclosure relate to data processing and, more specifically, to database uniqueness constraints.

### BACKGROUND

Databases can be implemented across multiple locations or data centers. Doing so can ensure that data is not lost, even in the event of a failure or malfunction of one of the data centers. Additionally, by distributing data centers in different geographic areas, users accessing such data centers can experience increased performance. Operations that are performed on the database stored at one data center can be replicated or synchronized across other data center(s). In doing so, the consistency of the data can be ensured across the various data centers.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example network system, in accordance with an example embodiment.

FIG. 2 is a flow chart illustrating a method, in accordance with an example embodiment, for employing database uniqueness constraints.

FIG. 3A is a block diagram of the data center of FIG. 1, according to an example embodiment.

FIG. 3B is a block diagram of the data centers of FIG. 1, according to an example embodiment.

FIG. 4 is a block diagram illustrating components of a machine able to read instructions from a machine-readable medium and perform any of the methodologies discussed herein, according to an example embodiment.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different implementations of the present disclosure. It will be evident, however, to one skilled in the art, that the present disclosure may be practiced without all of the specific details.

It can be appreciated that in certain systems, a database can be configured such that only a single instance of certain types of records can be stored in the database. For example, with respect to a system that provides users a single paid subscription option, a database maintaining records of such subscriptions can be configured such that only a single subscription record can be stored for each user (by doing so, the database can ensure that multiple subscriptions will not be created for a single user). Accordingly, in certain implementations, various constraints such as unique constraints can be defined with respect to a database. Such constraints can dictate, for example, that certain fields/records in the database cannot be duplicated (for example, only one subscription record can exist in the database with respect to a particular user).

While such constraints can be effective in preventing duplicate records from being created in a database, it may also be advantageous to distribute a database across multiple locations or data centers (e.g., to increase security, redundancy, efficiency, etc.). In such cases, copies of the database can be stored at each data center, and operations (e.g., data insertions, modifications, deletions, etc.) performed on the database at one data center can be replicated/synchronized across other data centers. Being that multiple operations may be occurring at different data centers at the same time, it may not be advantageous to employ the referenced unique constraints (since, for example, it may not be efficient to ensure that a record does not exist at any other data center prior to inserting it at a particular data center). However, ensuring that the results of such constraints are achieved (and thus only a single record exists) is still advantageous.

Accordingly, described herein in various implementations are technologies, including methods, machine readable mediums, and systems, that enable database uniqueness constraints, e.g., in a distributed database environment. As described herein, a shadow table can be created at a data center and may correspond to various fields of the database that are associated with various unique constraints. Such unique constraints can be, for example, rules, properties, logic, etc. that are applied to and/or otherwise associated with the shadow table that define or dictate that certain types of data, records, etc. cannot be duplicated (and thus remain unique) within the shadow table (for example, only one subscription record can exist in the shadow table with respect to a particular user). Upon receiving a record at a data center (which can be inserted into a table of the database, e.g., a service table, on account of the fact that unique constraints have not been applied due to the distributed nature of the database), an attempt can also be made to insert such a record into the shadow table as well. Being that the shadow table is subject to the referenced unique constraints, the insertion to the shadow table may fail if a corresponding record is already present in the shadow table. In such a scenario (e.g., when the insertion of the record to the shadow table fails, due to the unique constraints), the insertion of the record to the service table can also fail. By implementing the shadow table, the results of the referenced unique constraints can be achieved (e.g., ensuring that multiple subscriptions will not be created for a single user) even in a scenario in which such unique constraints are not applied to the service table itself.

Accordingly, it can be appreciated that the described technologies are directed to and address specific technical challenges and longstanding deficiencies in multiple technical areas, including but not limited to databases, data management, and distributed systems. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein,

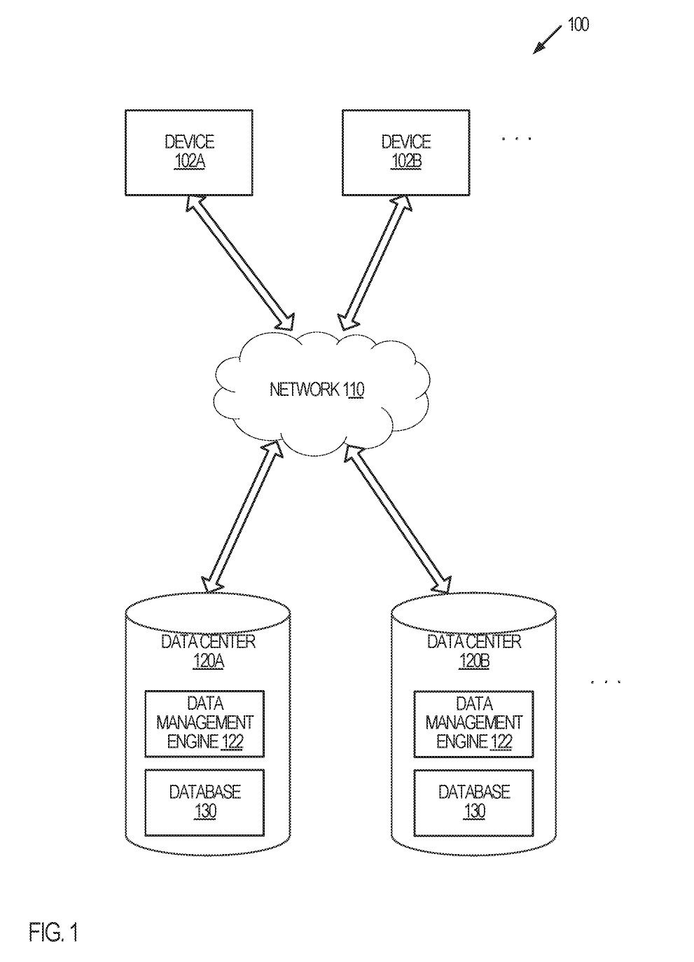

FIG. 1 illustrates an example network system 100, in accordance with some implementations. As shown, the system 100 includes various devices 102A-102B and data centers 120A-120B. The various devices 102 and data centers 120 can be connected to one another and capable of communicating with one another via a network 110. The network 110 can include one or more networks and can include one or more of the Internet, a wide area network (WAN), a local area network (LAN), a virtual private network (VPN), an intranet, and the like.

The described technologies can be implemented with multiple devices 102. Each device 102 (e.g., device 102A, as shown in FIG. 1) can be a laptop computer, a desktop computer, a mobile phone, a tablet computer, a smart watch, a personal digital assistant (PDA), a digital music player, a server, and the like. The devices 102 can be used to add data to a database 130, such as can be stored across multiple data centers 120 (e.g. data centers 120A and 120B, as shown in FIG. 1), as described herein.

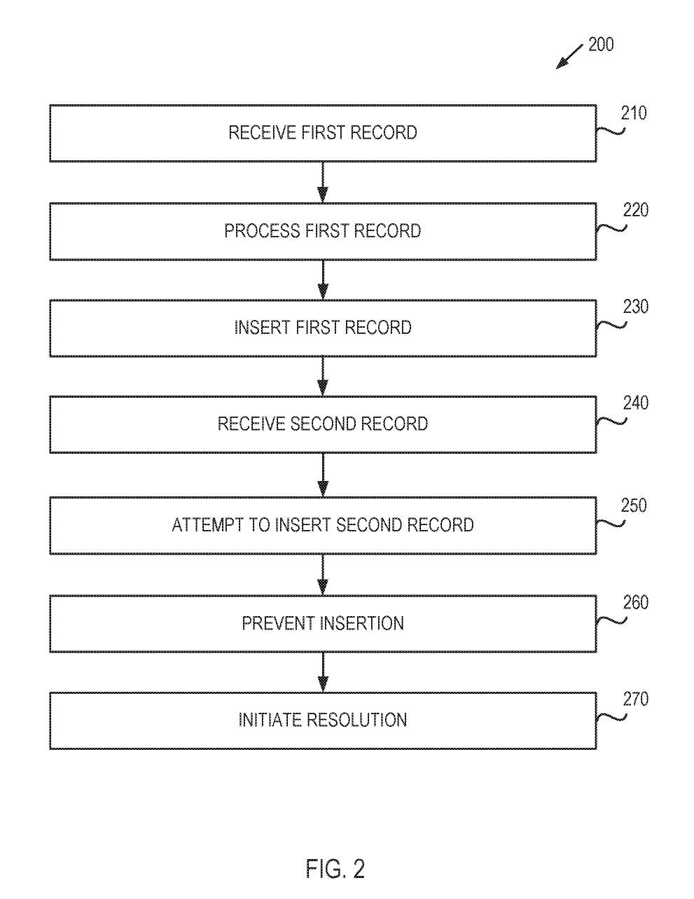

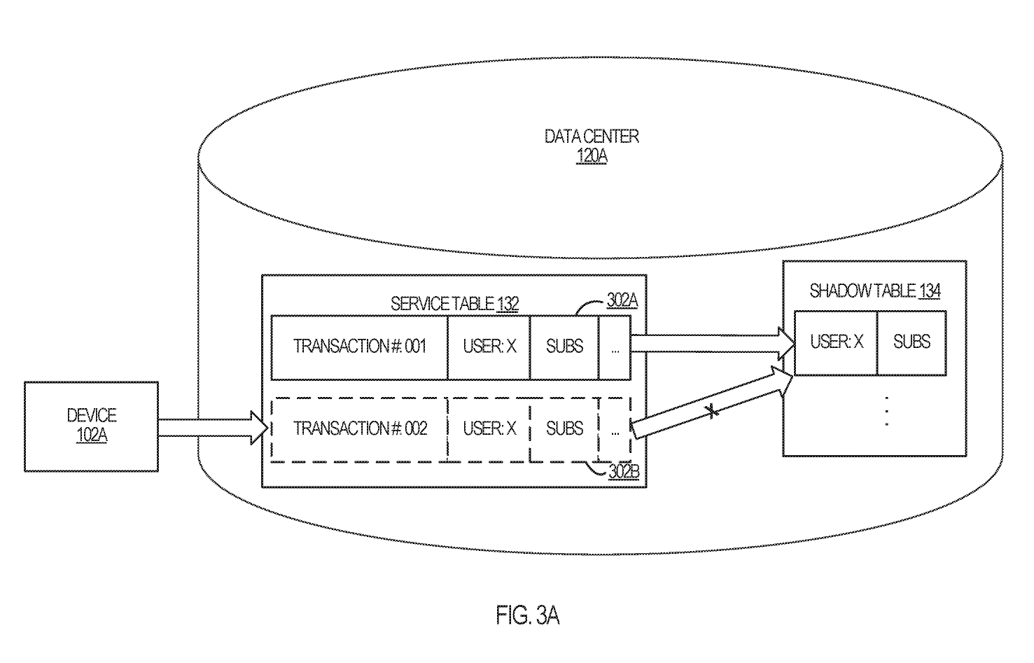

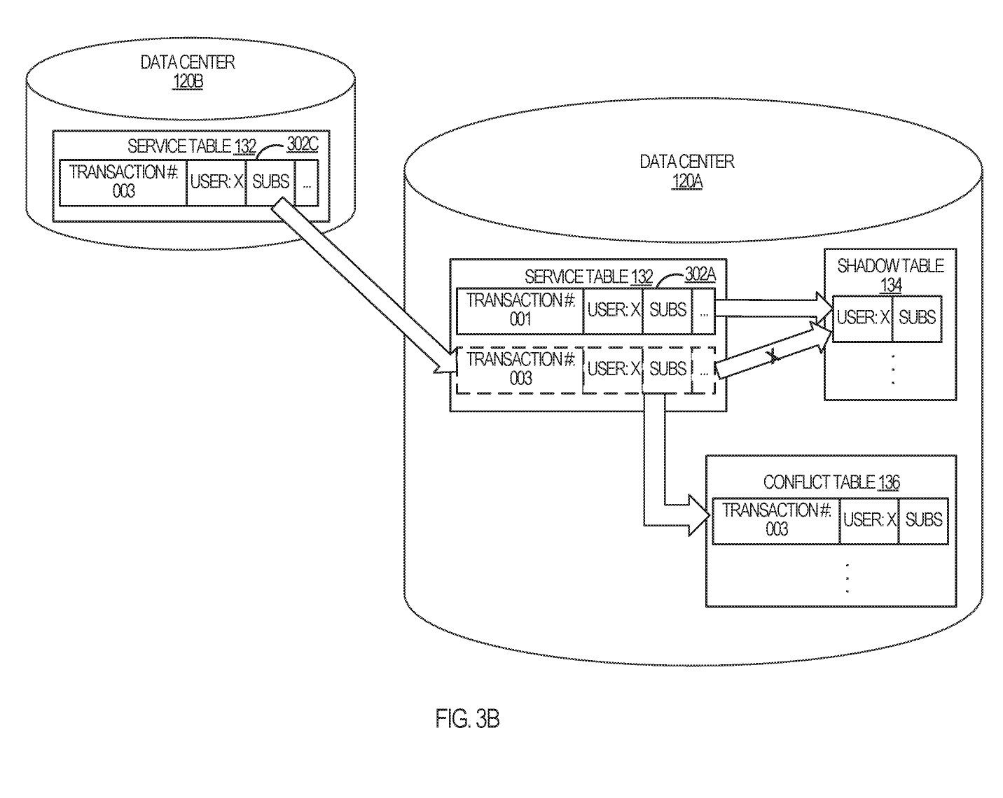

Each data center 120 (e.g., data centers 120A and 120B as shown in FIG. 1) can be implemented as a server machine, or any other such computing device capable of receiving and storing data. Data center 120 can include a database 130 which can be an object-oriented database, a relational database, or any other such data storage unit. Data center 120 can also include data management engine 122 which can be, for example, an application or module that manages the storage and retrieval of data within database 130, as described herein. As described herein, data can initially be provided (e.g., from device 102A) to a single data center (e.g., data center 120A) and inserted into database 130 as stored on that data center (e.g., data center 120A). The insertion of such data (or any other data modification operation) can then be communicated to other data center(s) (e.g., data center 120B), and the results of such insertion can be replicated at database 130 as stored on data center 120B. In doing so, the contents of databases 130 as stored on the respective data centers 120 can remain synchronized. It should be understood that maintaining database 130 across multiple data centers 120 may provide certain advantages with respect to data redundancy and efficiency (e.g., in scenarios in which such data centers are geographically distributed and can provide more efficient access to certain users). Further aspects and features of data centers 120 are described in more detail in conjunction with FIGS. 2-3B, below.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

FIG. 2 is a flow chart illustrating a method 200, according to an example embodiment, for employing database uniqueness constraints. The method is performed by processing logic that can comprise hardware (circuitry, dedicated logic, etc.), software (such as is run on a computing device such as those described herein), or a combination of both. In one implementation, the method 200 is performed by one or more elements depicted and/or described in relation to FIG. 1 (including but not limited to data center 120, data management engine 122, and/or database 130) and/or FIGS. 3A-3B, while in some other implementations, the one or more blocks of FIG. 2 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 210, a first record can be received. For example, such a record can be received at a location such as a data center (e.g., data center 120A) for insertion at a database (e.g., database 130 as stored at data center 120A, as shown in FIG. 1). As noted above, the referenced database can include various records that are stored and replicated across multiple locations such as data centers (e.g., data centers 120A and 120B). It should he understood that, in certain implementations, various aspects of operation 210 (as well as aspects of the various other operations of method 200 such as are depicted in FIG. 2 and/or described herein) can be performed by data center 120A, data management engine 122 and/or database 130, while in other implementations such aspects can be performed one or more other elements/components, such as those described herein.

By way of illustration, FIG. 3A depicts a block diagram of data center 120A of FIG. 1, in accordance with an example embodiment. As shown in FIG. 3A, an example record 302A has been received (and is stored in data center 120A, as is described herein). Such a record can include various fields which reflect, for example, certain aspects of a transaction, such as a transaction number (here, ‘001’), a user associated with the transaction (here, user ‘X’), and a transaction type (here, a subscription or ‘SUBS’). It should be understood that any number of additional fields may also he included in the referenced record 302A.

Referring back to FIG. 2, and at operation 220, the first record (e.g., the record received at operation 210) can be processed. In doing so, it can be determined whether one or more of the fields of the first record (e.g., record 302A, as shown in FIG. 3A) correspond to the one or more unique constraints that are defined with respect to the database 130 and/or a table of the database (e.g., service table 132 as shown in FIG, 3A), It should be understood that constraints can be, for example, various rules, properties, and/or logic that restrict, limit, or otherwise define the type(s) of data that can be stored in a particular database and/or table, field, etc. of a database (e.g., in order to maintain the accuracy and integrity of the data within the database, table, etc.). Accordingly, the referenced unique constraints can be a type of constraint (rules, properties, logic, etc.) that defines or dictates that certain types of data, records, etc. cannot be duplicated (and thus remain unique) within the database, table, etc. with respect to which such unique constraints apply. Thus, data, records, etc., that violate or do not otherwise comply with such a constraint (for example, an attempt to write/insert a record into a table that already contains another record of the same type and is subject to a unique constraint that dictates that a record of the referenced type cannot be duplicated within the table) cannot be stored, inserted, etc., within the database, table, etc., that is subject to the constraint. By way of illustration, in certain systems, a database (or a table of a database) can be configured such that only a single instance of certain types of records can be stored in the database (or the table). For example, with respect to a system that provides users a single paid subscription option, a database maintaining records of such subscriptions can be configured such that only a single subscription record can be stored for each user (by doing so, the database can ensure that multiple subscriptions will not be created for a single user) Accordingly, in certain implementations, various constraints such as unique constraints can be defined with respect to a database. Such constraints can dictate, for example, that certain data, fields, records, etc. in the database cannot be duplicated (for example, only one subscription record can exist in the database/table with respect to a particular user). Accordingly, upon receiving a record (e.g., for insertion into a database), such a record can be processed in order to determine whether various fields within the record (e.g., a subscription field) correspond to constraints (e.g., unique constraints), e.g., as may be defined with respect to the database.

At operation 230, the first record (e.g., the record received at operation 210) can be inserted into the database (e.g., the database as stored on the first data center). Referring again to FIG, 3A, record 302A (reflecting a purchase of a subscription by User ‘X’) can be inserted into service table 132 (which can be a table of database 130 which maintains records of various services associated with various users). Additionally, in certain implementations, the referenced record 302A can also be inserted into a shadow table 134. Such a shadow table 134 can be a table of database 130 (as stored on data center 120) that may be maintained in parallel to service table 132 and that may correspond to various fields of the database that are associated with the referenced unique constraints. For example, in a system configured such that a user may only have one ‘subscription’ service, the referenced shadow table can reflect field(s) of the database which correspond to such a constraint (here, the ‘user’ field and the subscription or ‘SUBS’ field). Accordingly, in addition to inserting record 302A into service table 132, upon determining that various fields of the record correspond to various unique constraints (e.g., determining that the record corresponds to a subscription), data center 120A, data management engine 122 and/or database 130 can insert a copy of the referenced record (or certain fields from the referenced record) into a shadow table e.g., shadow table 134, as shown in FIG. 3A).

Referring again to FIG. 2 and at operation 240, a second record can be received, e.g., at the first data center of the database, in certain implementations, this second record (e.g., record 302B as shown in FIG. 3A) can be received (e.g., from a device 102A) for insertion into the database 130. For example, as shown in FIG. 3A, data center 120A can receive record 302B which corresponds to another transaction (transaction ‘002’) in which a user (here, user ‘X’) has purchased a subscription.

In other implementations, the second record can be received from a second data center in conjunction with a replication operation. With reference to FIG. 1, multiple data centers (e.g., 102A and 102B) can maintain parallel copies of database 130, and operations (e.g., insert, modify, delete, etc.) performed on one data center can be replicated/synchronized across other data centers. Accordingly, and as shown in FIG. 3B, another record 302C may have been inserted into database 130 as stored on data center 120B and, during a replication/synchronization operation, such another record 302C can be provided to (and received by) data center 120A for insertion into database 130 as maintained on that data center (e.g., in order to ensure that the content of database 130 remains consistent across multiple data centers 120). As noted above, the receipt of record 302C by data center 120A may be in response to a replication/synchronization operation initiated by a second data center (e.g., data center 120B). For example, as shown in FIG. 3B, during a replication/synchronization operation, data center 120A can receive (from data center 120B) record 302C which corresponds to another transaction (transaction ‘003’) in which a user (here, user ‘X’) has purchased a subscription.

At operation 250, data center 120A, data management engine 122 and/or database 130 can attempt to insert the second record (e.g., the record revived at operation 240) into the shadow table. In particular, in addition to attempting to insert the received record into the service table 132, an attempt can also be made to insert the record into shadow table 134. As noted above, shadow table 134 corresponds to various unique constraints that dictate which types of records may not be duplicated within a database (e.g., only a single subscription record may exist for a single user). Accordingly, while service table 132 itself may not be subject to such unique constraints (in order to enable efficient utilization of the table, thereby allowing multiple ongoing operations to take place without awaiting synchronization/replication of records across multiple data centers), shadow table 134 can maintain such constraints and can serve to verify whether or not an operation may violate or conflict the constraints, as described herein.

At operation 260, insertion of the second record (e.g., the record received at operation 240) into the database as stored on the first data center can be prevented, stopped, or otherwise precluded. In certain implementations, the insertion of such a record into the database can be prevented in response to a determination (e.g., at operation 250) that the second record conflicts with the first record as stored in the shadow table 134 (e.g., based on/with respect to the unique constraints). For example, as shown in FIG. 3A, upon attempting to insert record 302B into shadow table 134, data center 120A, data management engine 122 and/or database 130 can determine that shadow table 134 already includes a record corresponding to user ‘X’ and a service subscription (‘SUBS’), which, as noted, are subject to unique constraints. Accordingly, based on the referenced constraints, the insertion of record 302B (which also corresponds to user ‘X’ and a subscription) conflicts with a record already present in the shadow table 134. Upon determining that insertion of a record conflicts with a record in the shadow table, the corresponding insertion of the record (here 302B) into the service table 132 can also be prevented, stopped, etc. By implementing the shadow table, the results of the referenced unique constraints can be achieved (e.g., ensuring that multiple subscriptions will not be created for a single user) even in a scenario in which such unique constraints are not applied to the service table 132 itself.

By way of further example, as shown in FIG. 3B, upon attempting to insert record 302C into shadow table 134, it can be determined that shadow table 134 already includes a record corresponding to user ‘X’ and a service subscription (‘SUBS’), which, as noted, are subject to unique constraints. Accordingly, based on the referenced constraints, the insertion of record 302C conflicts with a record already present in the shadow table 134 and therefore the corresponding insertion of the record (here 302C) into the service table 132 can also be prevented, stopped, etc.

At operation 270, a resolution of the conflict between the first record and the second record can be initiated by data center 120A, data management engine 122 and/or database 130. For example, as described above, a conflict may arise in conjunction with a replication/synchronization operation across multiple data centers, and it may be necessary to resolve such a conflict (e.g., in order to determine which record is to be maintained going forward). Such a conflict may arise in a scenario in which a record is received (e.g., from another data center during a replication operation) for insertion into a table. Upon comparing such a received record with record(s) already present in the shadow table (that corresponds to/is associated with the table with respect to which the record has been received for insertion), it can be determined (e.g., at operation 260) that another record of the same type is already present in the shadow table. As a result of the unique constraints associated with the shadow table which dictate that such a record cannot be duplicated within the shadow table (as described above), such a received record conflicts with the record of the same type that is already stored in the shadow table (in that the unique constraints associated with the shadow table dictate that, by virtue of the presence of a record of the same type within the shadow table, the received record cannot also be inserted/stored within the shadow table). Accordingly, in certain implementations, upon determining (e.g., at operation 260) that such a conflict exists between a first record (e.g., a record stored in data center 120A) and a second record (e.g., a record received from data center 120B during a replication operation), the referenced second record can be inserted into a conflict table. Such a conflict table can define a table of the database (e.g., as stored at the first data center) that stores record(s) received from other data centers (e.g., during replication operations) that, by virtue of/based on various unique constraints, cannot be inserted into a shadow table (e.g., the shadow table that corresponds to/is associated with the table with respect to which the record has been received for insertion).

For example, as shown in FIG. 3B, upon determining (using shadow table 134) that the insertion of record 302C (as received from data center 120B) conflicts with record 302A at data center 1201, record 302C can be inserted into a conflict table 136 (e.g., as maintained at data center 120A). Conflict table 136 can be, for example, a table of database 130 (as stored on data center 120A) in which those records that cannot be inserted into service table 132 (e.g., on account of a conflict, e.g., with respect to shadow table 134, as referenced above) can be stored. In certain implementations, upon inserting a record into the conflict table 136 (and/or upon determining that a record is present within the table), a notification corresponding to a presence of the record within the conflict table can be generated and/or transmitted (e.g., to an administrator). Such a notification can, for example, alert the administrator to the referenced conflict and/or to the presence of the record within the conflict table 136 (thereby enabling the administrator to manually resolve the conflict between the referenced records).

Additionally, in certain implementations the referenced resolution can be achieved or completed in an automated fashion. For example, in certain implementations various resolution criteria can be defined, e.g., with respect to the referenced unique constraints. Such resolution criterion can specify various rules, logic, etc. based upon which a record (e.g., among various conflicting records) to be maintained within the database (and/or removed from the database) can be identified, determined, etc. By way of illustration, such resolution criteria can reflect, for example, that (in the event of a conflict between multiple records) the earliest subscription record is to be maintained, or the latest subscription record is to be maintained, or the most expensive subscription record is to be maintained, etc. Based on such defined criteria, the conflict between multiple records (e.g. records 302A and 302C, as shown in FIG. 3B) can be resolved, e.g. by removing, deleting, etc. one of the records from the database 130, e.g., as stored at data center 120A (and/or data center 120B) based on the referenced resolution criteria.

It should also be noted that while the technologies described herein are illustrated primarily with respect to database uniqueness constraints, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated. Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission(e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-3B are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

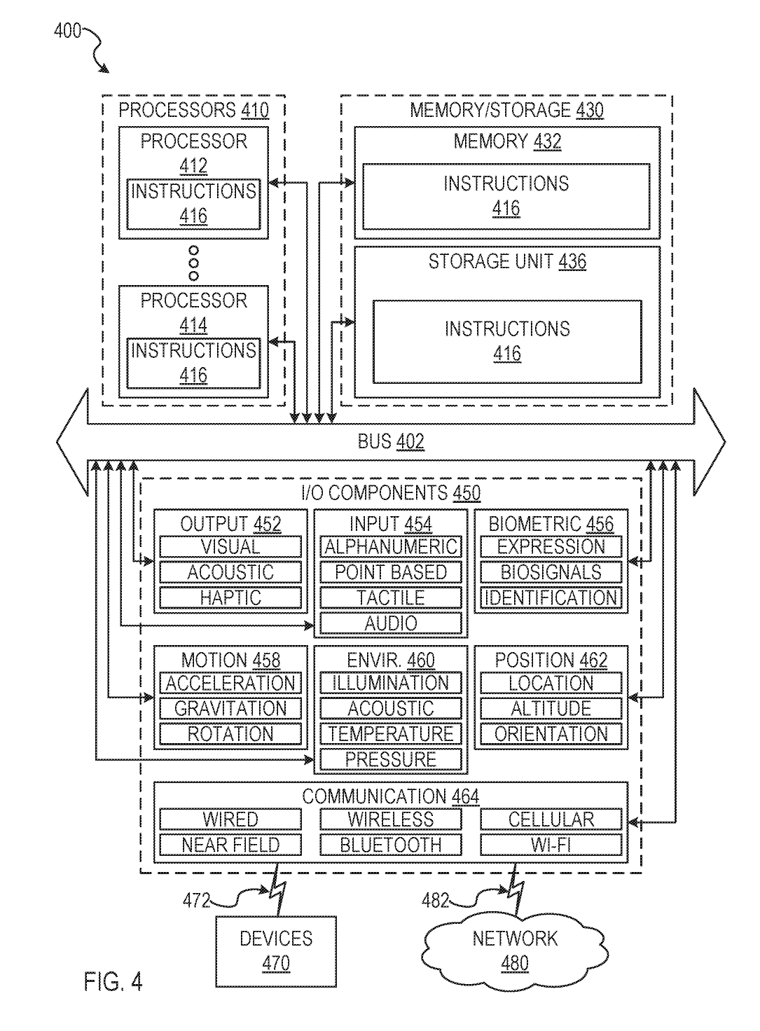

FIG. 4 is a block diagram illustrating components of a machine 400, according to some example implementations, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein can be executed. The instructions 416 transform the general, non-programmed machine into a particular machine programmed to carry out the described and illustrated functions in the manner described. In alternative implementations, the machine 400 operates as a standalone device or can be coupled (e.g., networked) to other machines. In a networked deployment, the machine 400 can operate in the capacity of a server machine or a client machine in a server-client network environment, or as a peer machine in a peer-to-peer (or distributed) network environment. The machine 400 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 416, sequentially or otherwise, that specify actions to be taken by the machine 400. Further, while only a single machine 400 is illustrated, the term “machine” shall also be taken to include a collection of machines 400 that individually or jointly execute the instructions 416 to perform any one or more of the methodologies discussed herein.

The machine 400 can include processors 410, memory/storage 430, and I/O components 450, which can be configured to communicate with each other such as via a bus 402. In an example implementation, the processors 410 (e.g., a Central Processing Unit (CPU), a Reduced Instruction Set Computing (RISC) processor, a Complex instruction Set Computing (CISC) processor, a Graphics Processing Unit (GPU), a Digital Signal Processor (DSP), an ASIC, a Radio-Frequency Integrated Circuit (WIC), another processor, or any suitable combination thereof) can include, for example, a processor 412 and a processor 414 that can execute the instructions 416. The term “processor” is intended to include multi-core processors that can comprise two or more independent processors (sometimes referred to as “cores”) that can execute instructions contemporaneously. Although FIG. 4 shows multiple processors 410, the machine 400 can include a single processor with a single core, a single processor with multiple cores (e.g., a multi-core processor), multiple processors with a single core, multiple processors with multiples cores, or any combination thereof.

The memory/storage 430 can include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 can also reside, completely or partially, within the memory 432, within the storage unit 436, within at least one of the processors 410 (e.g., within the processor's cache memory), or any suitable combination thereof, during execution thereof by the machine 400. Accordingly, the memory 432, the storage unit 436, and the memory of the processors 410 are examples of machine-readable media.

As used herein, “machine-readable medium” means a device able to store instructions (e.g., instructions 416) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 416. The term “machine-readable medium” shall also be taken to include any medium, or combination of multiple media, that is capable of storing instructions (e.g., instructions 416) for execution by a machine (e.g., machine 400), such that the instructions, when executed by one or more processors of the machine (e.g., processors 410), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 can include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG, 4. The I/O components 450 are grouped according to functionality merely for simplifying the following discussion and the grouping is in no way limiting. In various example implementations, the I/O components 450 can include output components 452 and input components 454. The output components 452 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 450 can include biometric components 456, motion components 458, environmental components 460, or position components 462, among a wide array of other components. For example, the biometric components 456 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 can include acceleration sensor components (e.g., accelerometer), gravitation sensor components, rotation sensor components (e.g., gyroscope), and so forth. The environmental components 460 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 462 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 450 can include communication components 464 operable to couple the machine 400 to a network 480 or devices 470 via a coupling 482 and a coupling 472, respectively. For example, the communication components 464 can include a network interface component or other suitable device to interface with the network 480. In further examples, the communication components 464 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., a peripheral device coupled via a USB).

Moreover, the communication components 464 can detect identifiers or include components operable to detect identifiers. For example, the communication components 464 can include Radio Frequency Identification (RFD) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 464, such as location via Internet Protocol (IP) geolocation, location via Wi-Fi® signal triangulation, location via detecting an NFC beacon signal that can indicate a particular location, and so forth.

In various example implementations, one or more portions of the network 480 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 can include a wireless or cellular network and the coupling 482 can be a Code Division Multiple Access (CDMA) connection, a Global System for Mobile communications (GSM) connection, or another type of cellular or wireless coupling. In this example, the coupling 482 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 416 can be transmitted or received over the network 480 using a transmission medium via a network interface device e.g., a network interface component included in the communication components 464) and utilizing any one of a number of well-known transfer protocols (e.g., HTTP). Similarly, the instructions 416 can be transmitted or received using a transmission medium via the coupling 472 (e.g., a peer-to-peer coupling) to the devices 470. The term “transmission medium” shall be taken to include any intangible medium that is capable of storing, encoding, or carrying the instructions 416 for execution by the machine 400, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example implementations, various modifications and changes may be made to these implementations without departing from the broader scope of implementations of the present disclosure. Such implementations of the inventive subject matter may be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations may be used and derived therefrom, such that structural and logical substitutions and changes may be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various implementations of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A method comprising:
receiving a first record for insertion at a database as stored at a first location, wherein the database comprises a plurality of records that are replicated across the first location and a second location;
inserting the first record into (a) the database as stored at the first location and (b) a shadow table that corresponds to one or more fields of the database as stored at the first location that are associated with one or more unique constraints, wherein at least one unique constraint defines a record that cannot be duplicated within the shadow table;
receiving a second record at the first location;
attempting to insert the second record into the shadow table; and
in response to a determination that the second record conflicts with the first record as stored in the shadow table with respect to the one or more unique constraints, preventing insertion of the second record into the database as stored at the first location.

2. The method of claim 1, further comprising processing the first record to determine whether one or more fields of the first record correspond to the one or more unique constraints that are defined with respect to the database.

3. The method of claim 2, wherein inserting the first record comprises inserting the first record into the shadow table in response to a determination that the one or more fields of the first record correspond to the one or more unique constraints.

4. The method of claim 1, wherein receiving a second record at the first location comprises receiving the second record from the second location in conjunction with a replication operation initiated by the second location.

5. The method of claim 4, further comprising initiating a resolution of the conflict between the first record and the second record.

6. The method of claim 5, wherein initiating a resolution comprises inserting the second record into a conflict table, the conflict table defining a table of the database as stored at the first location that stores one or more records received from one or more other locations that cannot be inserted into the shadow table based on the one or more unique constraints.

7. The method of claim 6, wherein initiating a resolution comprises transmitting a notification corresponding to a presence of the second record in the conflict table.

8. The method of claim 5, wherein initiating a resolution comprises:
identifying one or more resolution criterion with respect to the one or more unique constraints, at least one resolution criterion specifying one or more rules based upon which a record to be maintained within the database can be identified; and
removing at least one of the first record or the second record from the database as stored at the first location based on the one or more resolution criterion.

9. A system comprising:
a processing device; and
a memory coupled to the processor and storing instructions that, when executed by the processing device, cause the system to perform operations comprising:
receiving a first record for insertion at a database as stored at a first location, wherein the database comprises a plurality of records that are replicated across the first location and a second location;
inserting the first record into (a) the database as stored at the first location and (b) a shadow table that corresponds to one or more fields of the database as stored at the first location that are associated with one or more unique constraints, wherein at least one unique constraint defines a record that cannot be duplicated within the shadow table;
receiving a second record at the first location;
attempting to insert the second record into the shadow table; and
in response to a determination that the second record conflicts with the first record as stored in the shadow table with respect to the one or more unique constraints, preventing insertion of the second record into the database as stored at the first location.

10. The system of claim 9, wherein the memory further stores instructions for causing the system to perform operations comprising processing the first record to determine whether one or more fields of the first record correspond to the one or more unique constraints that are defined with respect to the database.

11. The system of claim 10, wherein inserting the first record comprises inserting the first record into the shadow table in response to a determination that the one or more fields of the first record correspond to the one or more unique constraints.

12. The system of claim 9, wherein receiving a second record at the first location of the database comprises receiving the second record from the second location in conjunction with a replication operation initiated by the second location.

13. The system of claim 12, wherein the memory further stores instructions for causing the system to perform operations comprising initiating a resolution of the conflict between the first record and the second record.

14. The system of claim 13, wherein initiating a resolution comprises inserting the second record into a conflict table, the conflict table defining a table of the database as stored at the first location that stores one or more records received from one or more other locations that cannot be inserted into the shadow table based on the one or more unique constraints.

15. The system of claim 14, wherein initiating a resolution comprises transmitting a notification corresponding to a presence of the second record in the conflict table.

16. The system of claim 13, wherein initiating a resolution comprises:
identifying one or more resolution criterion with respect to the one or more unique constraints, at least one resolution criterion specifying one or more rules based upon which a record to be maintained within the database can be identified; and
removing at least one of the first record or the second record from the first location based on the one or more resolution criterion.

17. A non-transitory computer readable medium having instructions stored thereon that, when executed by a processing device, cause the processing device to perform operations comprising:
receiving a first record for insertion at a database as stored at a first location, wherein the database comprises a plurality of records that are replicated across the first location and a second location;
inserting the first record into (a) the database as stored at the first location and (b) a shadow table that corresponds to one or more fields of the database as stored at the first location that are associated with one or more unique constraints, wherein at least one unique constraint defines a record that cannot be duplicated within the shadow table;
receiving a second record at the first location;
attempting to insert the second record into the shadow table; and
in response to a determination that the second record conflicts with the first record as stored in the shadow table with respect to the one or more unique constraints, preventing insertion of the second record into the database as stored at the first location.

18. The computer-readable medium of claim 17, wherein receiving a second record at the first location of the database comprises receiving the second record from a second location in conjunction with a replication operation initiated by the second location.

19. The computer-readable medium of claim 18, wherein the memory further stores instructions for causing the system to perform operations comprising initiating a resolution of the conflict between the first record and the second record.

20. The computer-readable medium of claim 19, wherein initiating a resolution comprises inserting the second record into a conflict table, the conflict table defining a table of the database as stored at the first location that stores one or more records received from one or more other locations that cannot be inserted into the shadow table based on the one or more unique constraints.
